(19) United States
(12) Patent Application Publication
(10) Pub. No.: US 2010/0231375 A1
(43) Pub. Date: Sep. 16, 2010

(54) INFORMATION DISPLAY AND COMMUNICATION SYSTEM FOR PAINTBALL

(75) Inventors: Michael Newman, Smithtown, NY (US); Christian Williams, Glendale, UT (US); Sorin Petrusan, Timis (RO); Jukka Fiskari, Helsinki (FI)

Correspondence Address: SCULLY SCOTT MURPHY & PRESSER, PC, 400 GARDEN CITY PLAZA, SUITE 300, GARDEN CITY, NY, 11530, US

(73) Assignee: VIRTUE PAINTBALL LLC, Hauppauge, NY (US)

(21) Appl. No.: 12/402,139

(22) Filed: Mar. 11, 2009

(51) Int. Cl. G08B 5/00; F41B 11/00

(52) U.S. Cl. 340/500; 124/56; 124/45; 124/1

(57) ABSTRACT

An information display and communication system for use with paintball equipment during a paintball game is provided. The information display and communication system includes a display unit disposed on a housing; a wireless communication unit provided in the housing for receiving information from a paintball marker system; and a controller provided in the housing for displaying the received information on the display unit. The system can be constructed as a portable unit or incorporated into the body of a paintball marker or paintball hopper. Ideally, the display unit includes a touch screen input unit for providing user interaction with the information unit. The wireless communication unit utilizes a short range communication protocol, such as Bluetooth, IR, etc. Additionally, a second wireless communication unit is included having a longer communication range for communicating with other information display and communication systems and players.

### FIELD OF THE INVENTION

The present invention relates generally to the game of paintball and more specifically to an information display and communication system for use in paintball.

### BACKGROUND OF THE DISCLOSURE

Paintball is a sport in which players eliminate opponents from play by hitting them with paint filled, breakable, gelatin paintballs usually shot from a carbon dioxide or compressed air powered paintball marker. Paintball draws a wide array of people, and the Sporting Goods Manufacturer's Association estimates that over 10 million people play the game in the United States annually, with 1.9 million playing at least 15 times a year.

A game of paintball usually involves two opposing teams seeking to eliminate all of the other team's players or to complete some other objective, such as retrieving a flag, eliminating a specific player, or other paintball variations. Depending on the style of paintball played, a paintball game can last from seconds to days, although typical games are five to thirty minutes long.

Paintball can be played either in an indoor arena or outdoors. When played outdoors, the play area can be a large wooded area or other large terrain that offers typology simulating a battlefield allowing players to maneuver against each other.

However, as players tend to quickly move away from fellow teammates during game play, it becomes difficult for strategies and tactics to be formulated and changed during game play. Moreover, it is difficult know the status of fellow teammates.

Generally, two types of paintball markers are available in the sport of paintball, mechanical and electronic.

Mechanical paintball markers rely on blowback to re-cock the paintball marker when the trigger is pulled in preparation for another shot. On the other hand, electronic paintball markers rely on electronically controlled solenoids to reroute pressurized gas inside the paintball marker in order to fire a paintball and recock. The electronic paintball marker provides increased accuracy by reducing recoil, allows for faster firing, and provides customizable firing schemes, such as single fire per trigger pull, multi-fire per trigger pull or continuous fire while trigger is held.

Additionally, there are many variations of paintball hoppers, such as gravity feed, agitating, and force-feed.

A gravity feed hopper is essentially a large container with a feed tube molded into the bottom. Paintballs roll down the sloped sides, through the tube, and into the paintball marker. These hoppers are limited to feeding eight paintballs per second reliably. Gravity feed hoppers are very cheap, since they are made of only a shell and a lid, but can become jammed easily as paintballs pile up above the tube. Occasionally, rocking the paintball marker and hopper can keep the paintballs from jamming at the feed neck.

This problem is made worse when using a modern fully electronic paintball marker. Most mechanical paintball markers use a blowback system for recocking, or other methods where a large reciprocating mass is involved. This will shake the balls in the hopper slightly, facilitating gravity feed. A paintball marker with both electronically controlled recocking and firing will often exhibit no shake whatsoever while operating. Because of this, feeding problems are increased.

Agitating hoppers use a propeller spinning inside the container to agitate, or stir up, the paintballs. This prevents the paintball from jamming at the feed neck. Consequently, agitating hoppers can load paintballs into the firing chamber of the paintball marker more rapidly than equivalent gravity feed hoppers.

There are two types of agitating hoppers: those with “eyes” and those without. The eyes consist of a LED (light emitting diode), and a photodetector (typically a phototransistor or photodiode) inside the neck (tube) of the hopper and are often inside electronic paintball markers. Eyes are used to detect whether a ball is present or not. In a paintball marker, the eyes will keep the marker from shooting until a bail is fully loaded into the chamber. In a hopper, the eyes detect when a ball is not present in the hopper neck, and subsequently activate the propeller to load a paintball into the neck.

Force-feed hoppers utilize an impeller to capture paintballs and force them into the paintball marker. The impeller is either spring-loaded or powered by a belt system, allowing it to maintain constant pressure on the stack of paintballs in the feed tube. This allows force-feed hoppers to feed paintballs at high speed (over 22 balls per second), since the mechanism does not rely on gravity to move paintballs into the feed neck.

### SUMMARY OF THE DISCLOSURE

An embodiment of the present invention is an information unit having a portable housing; a display unit disposed on the housing; a wireless communication unit provided in the housing for receiving information from a paintball marker system; and a controller provided in the housing for displaying the received information on the display unit. Ideally, the display unit includes a touch screen input unit for providing user interaction with the information unit. The wireless communication unit utilizes a short range communication protocol, such as Bluetooth, IR, etc. Additionally, the communication unit can include a command transmitting unit for transmitting operation commands to the paintball marker system. The operating commands include commands for setting rate of fire as well as other commands for controlling the paintball marker system.

Alternatively, the information unit of the present invention can be incorporated into a paintball marker body or a paintball hopper body.

Furthermore, a position determining unit, such as GPS, can be provided either as an add-on module or integrated into the portable housing for determining current position of said information unit with respect to at least a play area. A second wireless communication unit for receiving external information is also provided in the portable housing, allowing the information unit to communicate with other information units within communication range.

### BRIEF DESCRIPTION OF THE DRAWINGS

These and other features, aspects, and advantages of the present invention will become better understood with regard to the following description, appended claims, and accompanying drawings wherein:

FIG. 1 illustrates a paintball marker system including an embodiment of the present invention;

FIG. 2 illustrates an external view of an embodiment of the present invention;

FIG. 3 illustrates a block representation of an embodiment of the present invention;

FIG. 4 illustrates a representation of a paintball match showing usage of an embodiment of the present invention;

FIG. 5 illustrates an embodiment of the present invention incorporated into a paintball mask assembly; and

FIGS. 6-14 illustrate training modes of an embodiment of the present invention.

### DETAILED DESCRIPTION OF DISCLOSURE

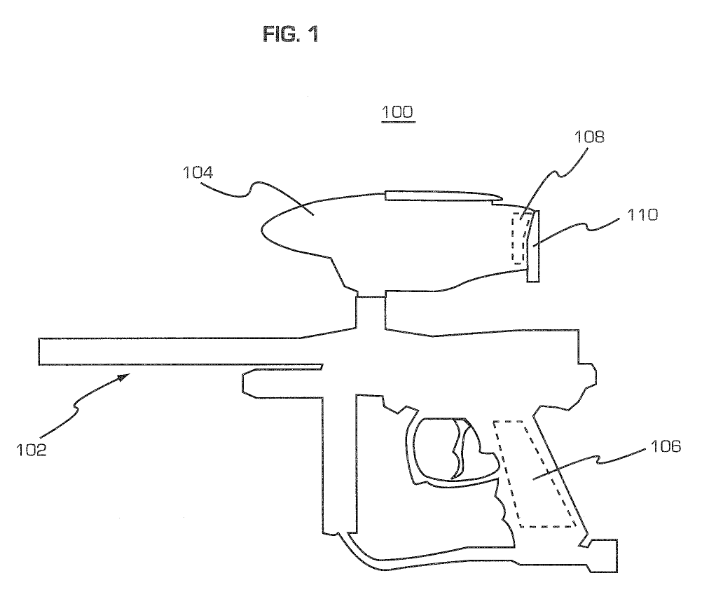

Referring to FIG. 1 a paintball marker system 100 is shown. The paintball marker system 100 includes a paintball marker 102 and a paintball hopper 104. In the case of an electronic paintball marker 102, electronics 106 for controlling various operating features of the paintball marker 102 are disposed in the grip. In addition, electronics 108 may be disposed in the hopper as well. The hopper electronics 108 provide control for an agitator or an impeller as well as sensor eyes that may be included in the hopper, but not shown.

As shown in FIG. 1 an information display and communication system 110 is mounted on the hopper 104 at a position readily viewable by the player while actively engaged in game play. Alternatively, the information display and communication system 110 can be mounted on a rear portion of the paintball marker 102. In yet another alternative, the information display and communication system 110 is constructed as a portable unit that can be mounted on the player, for example, the information display and communication system 110 can be worn around the player's wrist or attached to a portion of the player's arm. As will be described below, the features of the information display and communication system 110 are not adversely affected by being mounted in any of the above-mentioned locations. The present invention can be used with any combination of paintball marker and hopper technologies, whether mechanical or electronic. However, to take full advantage of the features of the present invention, electronic paintball markers and either agitating or force-feed hoppers are preferred.

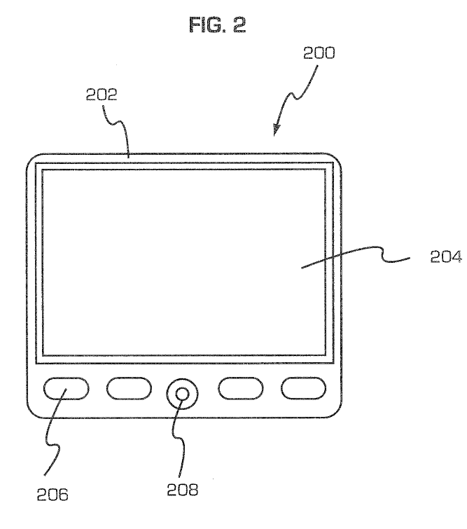

In FIG. 2 an embodiment of the information display and communication system 200 is shown. Portable housing 202 of the information display and communication system 200 protectively encloses the necessary electronics. Additionally, a display screen 204 and interface elements, such as buttons 206 and/or joystick 208, are provided on the housing 202.

The display screen 204 is preferably an organic light emitting diode display screen (OLED), however a liquid crystal display (LCD) may be substituted. Ideally, the display screen is equipped with a touch-sensitive surface so that a player may perform functions of the information display and communication system 200 by tapping on the screen rather than manipulating the interface elements. Use of a touch-sensitive surface allows for elimination of the interface elements altogether, allowing for a larger display screen 204 in the same size housing 202.

The information display and communication system 200 is not limited to the particular layout shown in FIG. 2. Rather, the interface elements, if provided, may be placed on the same surface with the display screen 204, or on one or more of the side surfaces of the housing 202. Additionally, interface elements are not limited to the number and type shown. Additional buttons 206, joysticks 208, dials, etc. may be provided as necessary to access the functions of the information display and communication system 200.

However, due to the limited space available, the number of interface elements should be minimized by dynamically assigning different actions to the provided buttons 206 and joystick 208 depending on a particular function being performed by the information display and communication system 200. Interface elements having actions dynamically allocated are commonly referred to as soft keys.

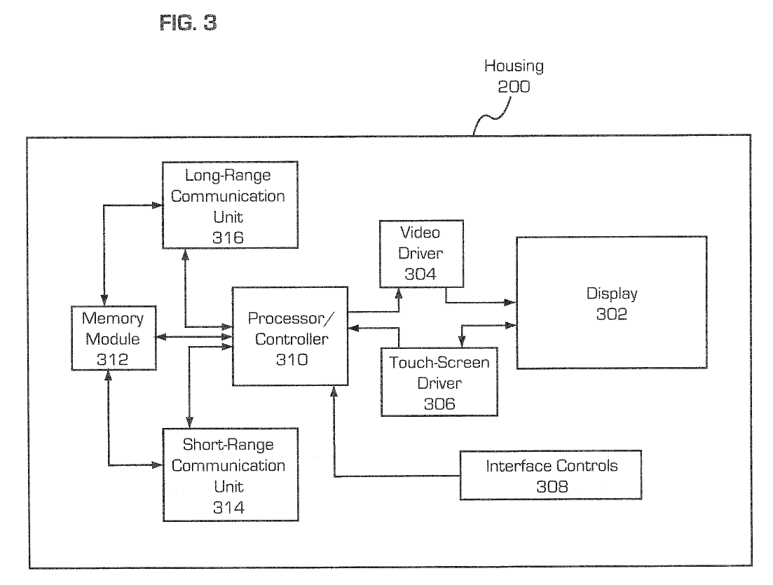

FIG. 3 is a block diagram of the major components of the information display and communication system contained within or on the housing 202. Arrows shown in the block diagram indicate the direction of data and command flow. For example the display 204 receives data for controlling the display from a video driver 304, while the touch-screen driver 306 receives data related to contact position, etc. from the display 204. Additionally, interface elements 308 provide control data to a processor/controller 310.

A memory module 312, ideally provided as solid-state memory circuits, is used for storing the software necessary by the processor/controller 310 for performing the various functions of the information display and communication system. In addition, the memory module 312 provides temporary buffer storage for both the short-range communication unit 314 and the long-range communication unit 316.

In an embodiment of the information display and communication system, the short-range communication unit 314 allows communication with and control of an individual player's paintball marker system. In this way, a player is able to easily adjust settings and view the status of the paintball marker system, as the short-range communication is preferably bi-directional between the information display and communication system and the paintball marker system. Communication protocols that are considered appropriate for use in the short-range communication unit 314 include: Infrared, low power RF, Bluetooth, as well as any other communication protocols known in the art.

In addition, the information display and communication system allows players of the same team to communicate with one another and with the team's coach using the long-range communication unit 316. Moreover, a referee can communicate with both paintball teams over the long-range communication unit 316 as well. The long-range communication unit 316 preferably uses a communication protocol that provides a signal coverage large enough to encompass the entirety of the playing field. Such protocols considered appropriate include: RF and any one of the protocols described under the IEEE 802.11x standards. However, any other protocol that provides sufficient signal coverage and data bandwidth may be used as well.

Regarding the long-range communication unit 316, in order to prevent information from being inadvertently sent to opposing players, each individual information display and communication system is uniquely addressable such that data can be sent to and received from specific players without non-designated players receiving the data. An encryption or security scheme can also be provided in the communication protocol to further limit access to data by opposing players. Addressing of each the information display and communication system can be performed using IP addresses, MAC addresses, unit serial numbers, or user defined identifiers.

The memory module 312 can be configured to store both the address or identifier of its own information display and communication system as well as the addresses or identifiers of the systems of fellow teammates, coaches and referees. Alternatively, in the case of a hardware address or serial number, a dedicated read-only memory module may be used.

In addition to the basic components shown in FIG. 3, the present invention can include other sub-systems such as a digital camera (not shown), position sensors 318, a global positioning satellite (GPS) system 320, an audio input/output unit (not shown), etc.

Position sensors 318 can be accelerometers or other sensors that can register motion and orientation of the system. The position sensors 318 provide information regarding motion of the housing 200, and by extension motion of the paintball marker to which the housing 200 is attached. Additionally, the position sensors 318 provide directional, or orientation, information such as whether the paintball marker is facing up or down, and north, south, east or west. The information display and communication system of the present invention can process this information along with information received from the OPS 320 to determine location and facing direction of the paintball marker. This information can then be provided to other team members or referees.

Moreover, the orientation information provided by the position sensors 318 can be used by the information display and communication system to control a fire safety feature, in which the paintball marker is prevented from firing when the orientation is straight down as this would be an indication that the paintball marker is not being aimed or intended to be used.

Also, powersaver modes can be provided that are activated by the information display and communication system when the position sensors 318 do not register any motion or change in orientation within a defined time interval, i.e. several minutes. Since no detection of motion for a prolonged period of time may indicate that the paintball marker was dropped or placed down and thus no longer being used by a player, the information display and communication system can initiate a mode that powers down certain power consuming electronics in order to conserve battery power. When motion is detected by the position sensors 318 once again, the information display and communication system can repower the systems thus placing the paintball marker back into a ready state.

The long-range communication unit 316, ideally, allows individual teammates to share information regarding positioning of themselves and opposing players, status of their own paintball marker systems, as well as plan tactics with one another. As such, the long-range communication unit 316 allows receipt and transmission of various types of data, including GPS position data, image data, audio data, and text. The status of a teammate's paintball marker system may be forwarded from the paintball marker system through the short-range communication unit 314 and processor/controller 3 10 to the long-range communication unit 316.

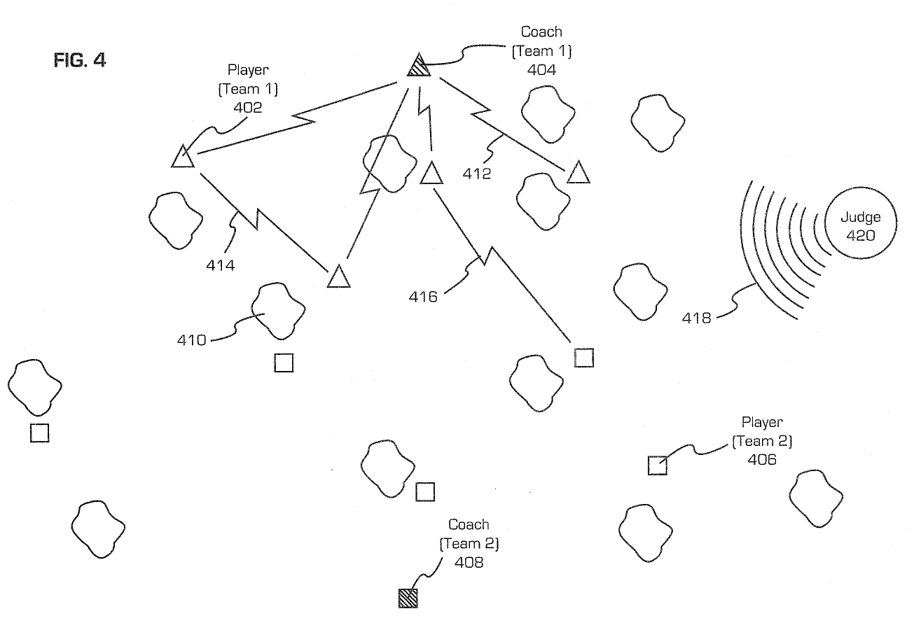

FIG. 4 provides a representation of a paintball tournament in which an embodiment of the information display and communication system is used. The following is a description of features of the information display and communication system. However, the described features are not intended to be limiting, but rather provide illustrative examples of features of the present invention. In view of the provided examples, one of ordinary skill in the art is capable of introducing other features deemed to be useful in paintball. Such additional features are also considered as part of the present invention.

In a paintball tournament, two teams—herein represented as triangles 402 for team 1 and squares 402 for team 2—attempt to eliminate all the players of the opposing team by marking each player with a paintball. The play area, whether indoors or outdoors, is provided with features 410 such as trees, walls, trenches, boulders, etc. that can be used by the individual players as protection or hiding spaces during the game.

Additionally, each team may have a coach 404 and 408 that provides tactical coordination to their respective team of players 402 and 406. A judge, or referee 420 controls the game so that the rules of the tournament are followed and determines whether or not players are eliminated.

As can be seen from the illustration, the various terrain features 410 can easily block fields of view of the players 402 and 406 and coaches 404 and 408. Consequently, it becomes difficult to coordinate attacks and defenses once the game has begun. However, use of an embodiment of the information display and communication system allows communication between teammates 414 and between players and coaches 412, thus increasing the coordination within a paintball team. Also, by allowing communication between players and referees 418, the paintball game can more efficiently be officiated since the referee is able to quickly notify all the players when a player is eliminated, or if a stoppage in play is required such as might occur in the case of an injury. Additionally, opposing players may be allowed to communicate with one another 416.

Moreover, the players using an embodiment of the information display and communication system can be provided with a map of the game area having a predetermined level of detail as an aid. The map can be uploaded to the information display and communication system by manually inserting a memory card (MMC, SD, etc.), connection via a cable to a computer, or by way of one of the communication units. The map is displayed on the display 302 and, if the information display and communication system is provided with GPS functionality, the current position of the player can be shown on the displayed map.

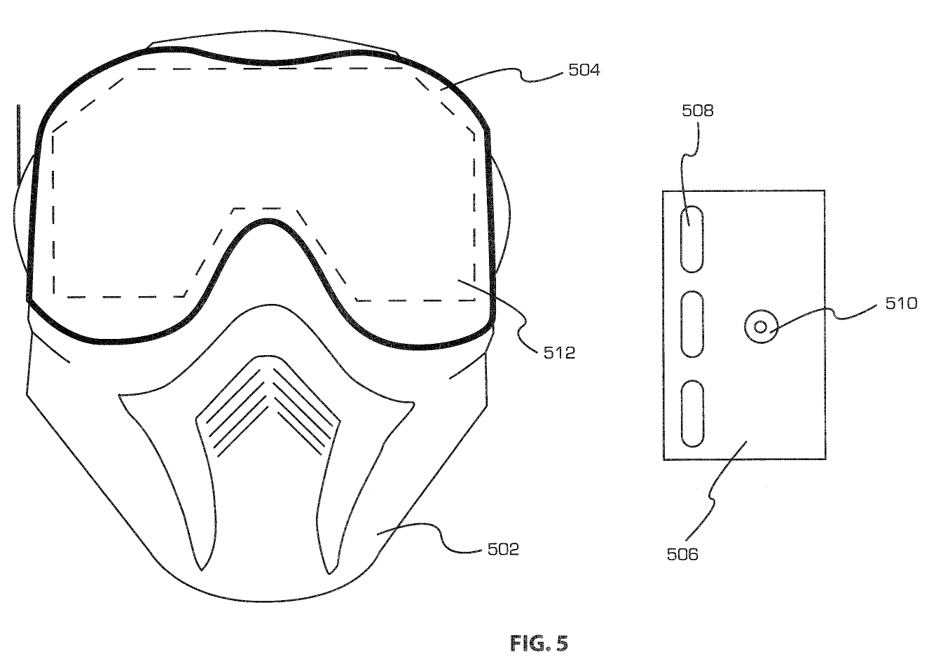

Referring to FIG. 5, a paintball mask 502 is shown, which is intended to protect a player from errant paintballs impacting the face and causing injury. An embodiment of the present invention is disposed in such a paintball mask 502. The present embodiment has a display 512 integrated into a goggle portion 504 of the paintball mask 502 using transparent OLED technologies to provide a heads-up display to the player.

Additionally, a control panel 506 is provided for allowing the wearer to interact with the information display and communication system of the present embodiment. The control panel 506 is disposed with a plurality of interface elements as discussed previously such as buttons 508, joysticks 510 and dials (not shown). Ideally, the control panel 506 is in remote wireless communication with the heads-up display 512. The control panel 506 is dimensioned to comfortably be worn on an easily accessible portion of the player's body, for example on an arm.

As with the previously described embodiments, the present embodiment communicates with the wearer's paintball marker using a short-range wireless communication protocol and with fellow teammates, coaches, referees and opponents by way of a long-range wireless communication protocol. The components shown in FIG. 3 are present in the present embodiment as well and disposed either in the paintball mask 502 or control panel 506, as appropriate.

As disclosed above, the present invention can communicate with and control a player's paintball marker. Through this control of the paintball marker, the information display and communication system can also provide training modes for developing various paintball skills. The training modes of the present invention can be initiated by way of a designated button on the control panel or by way of a menu item of a graphical user interface displayed on the display of the present invention. Ideally, these training modes allow a player to practice without requiring the expenditure of paintballs.

For performing the various training modes, the information display and communication device of the present invention is provided with a plurality of physical timers and counters or the ability to generate the timers and counters as needed in software. Additionally the information display and communication device includes buffers for temporarily storing timer and counter values. Moreover, the information display and communication device can detect when a trigger pull is performed. The trigger pull is indicative of a shot being fired.

Following are descriptions of several training modes incorporated into an embodiment of the present invention. The modes described herein are not intended as limiting the present invention to just these training modes. Rather, the training modes described are intended as examples from which one of ordinary skilled in the art can readily develop additional training modes and scenarios.

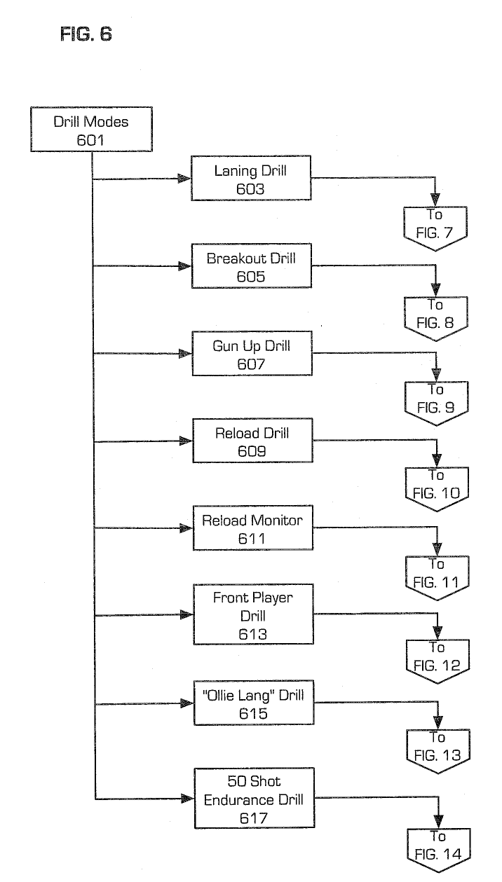

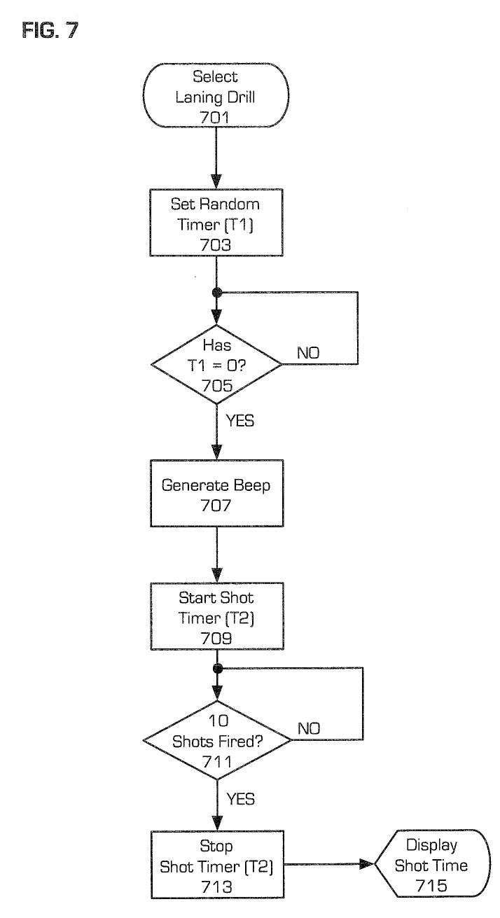

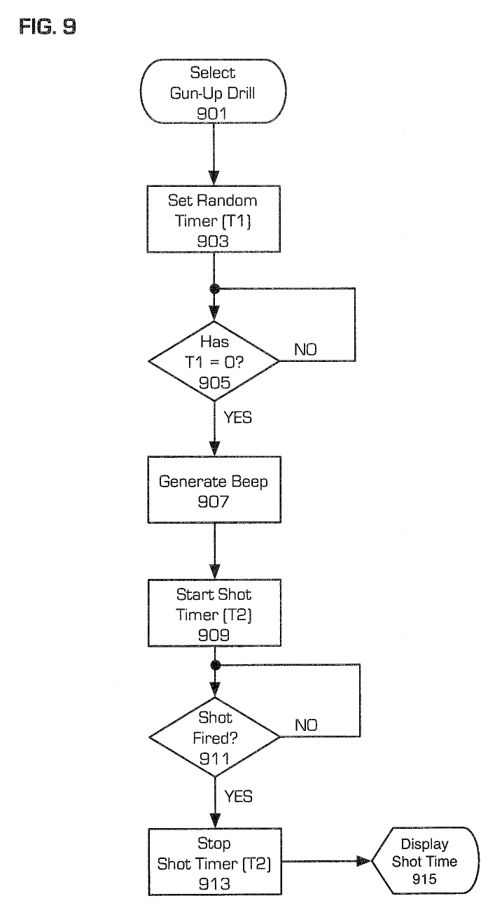

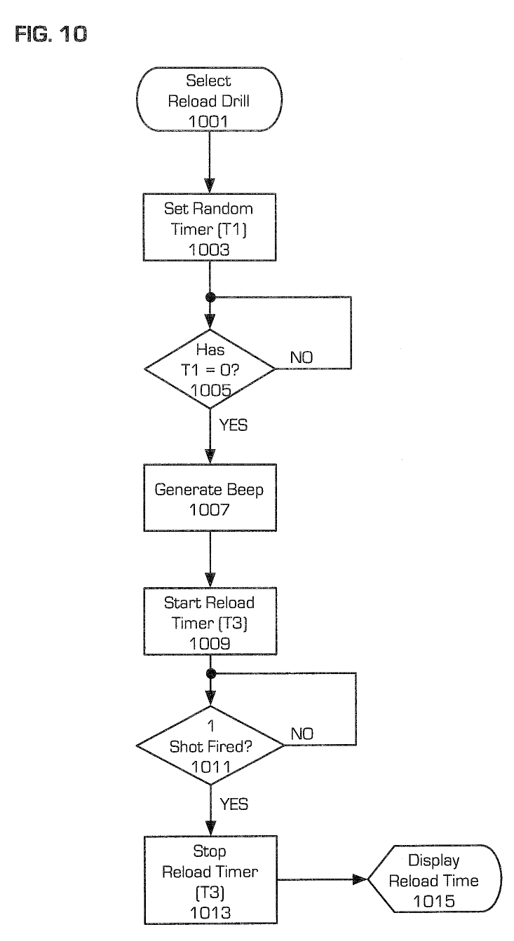

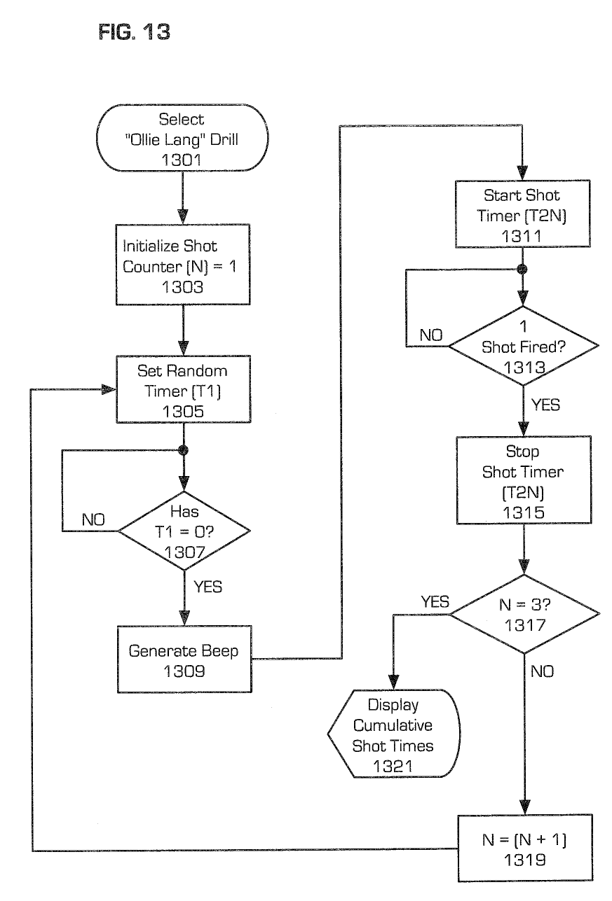

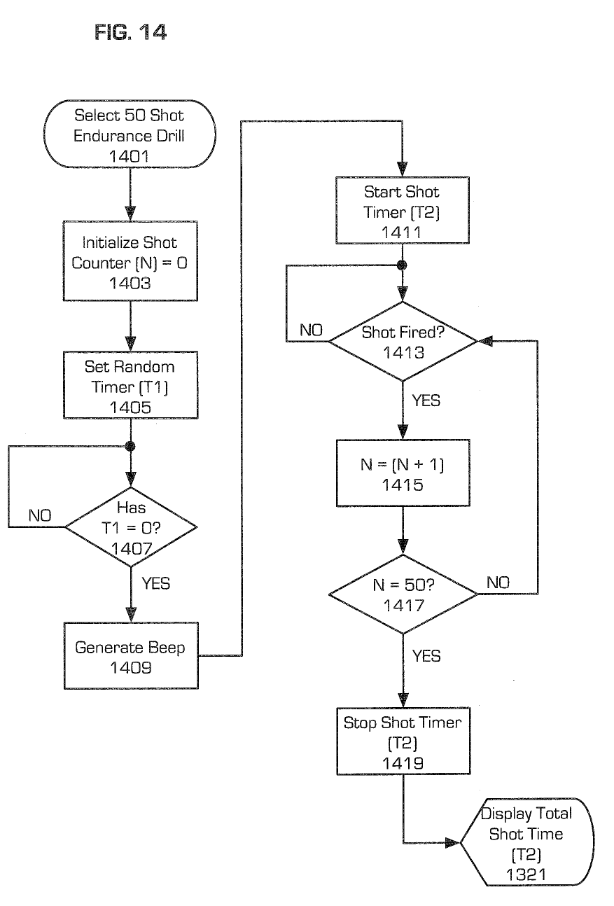

Referring to FIG. 6, a flow diagram for an on-screen drill modes menu 601 is shown providing access by a player to the available drill modes 603-617. Each of the available drill modes 603-617 are discussed in further detail below with reference to FIG. 7-14.

With the exception of the reload monitor drill mode 611, the system of the present invention checks that the paintball marker is unloaded. The drill modes 603-609 and 613-617 are enabled only with the paintball hopper emptied in order to conserve paintballs during training. Moreover, the present invention reduces the dwell time to reduce noise and wear on the paintball marker when in certain of the drill modes. The dwell time refers to the time period that a valve of the paintball marker is held open during firing. However, the present invention maintains normal operation of the paintball marker when in reload monitor drill mode 611.

The laning drill 603 allows the player to practice laning suppression fire. Laning suppression fire is a technique of inhibiting players on the opposing team from moving by rapidly firing a large number of paintballs. The key to laning suppression fire is the firing of paintballs as fast as possible. The laning drill provides an opportunity for a player to practice rapidly pulling the trigger on the paintball marker, thereby increasing rate of fire.

Referring to FIG. 7, a flow diagram is shown of the process performed by the present invention when laning drill mode is selected in step 701. The laning drill sets a random countdown timer (T1) in step 703. The countdown timer is set for a random duration of several seconds, typically between 5 to 9 seconds. When the timer expires, i.e. T1=0, in step 705, the process proceeds to step 707, where a beep or other notifying means is generated. A shot timer (T2) is started simultaneous with the beep of step 707, or nearly so. The process continues until 10 shots have been fired in step 711. The shot timer (T2) is stopped in step 713 and the elapsed time of the shot timer (T2) is displayed in step 715.

The breakout drill 605 allows one or more players to practice various breakout strategies. The fast pace of a typical paintball match can make the initial 30 seconds of game play critical in determining which team wins. Therefore, teams need to practice and develop breakout strategies.

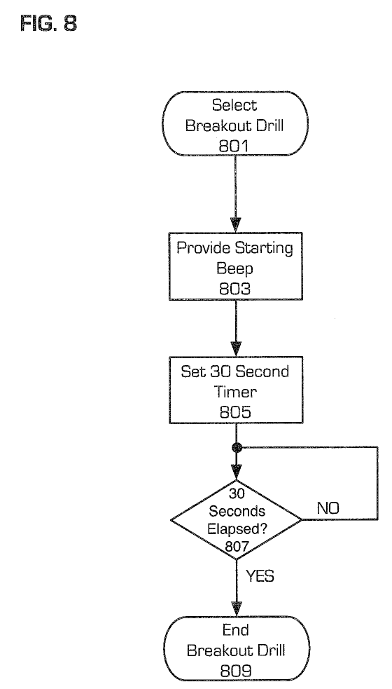

Referring to FIG. 8, the breakout drill is intended to be used during team practice, since it is most effective to evaluate breakout strategies with the full complement of players on the team. However, for this drill only one player need activate the breakout drill mode.

The breakout drill begins at step 801 with the player selecting the mode in the interface provided by the information display and communication device of the present invention. A start beep is provided in step 803 using a speaker, or other audio output component, incorporated in the information display and communication device. The beep should be loud enough to allow all the team members involved in the drill to hear the beep. Alternatively, a visual signal may be provided in place of the beep. However, if a visual signal is used, the information display and communication device initiating the breakout drill will need to provide signals to the other team members so they will know when to start and end the breakout drill.

The breakout drill sets a timer to 30 seconds in step 805. The timer elapses until the full 30 seconds have expired in step 807. Once the 30 seconds have elapsed, the breakout drill ends at step 809. The end of the drill can be marked by issuance of a second beep signifying completion.

The gun-up drill 607 helps improve a player's ability to quickly get into position to fire. This is an important skill in paintball since the ability to quickly bring a marker into position and fire can mean the difference between being eliminated from play or eliminating the opponent.

The player initiates the gun-up drill by selecting the mode in step 901. A random timer (T1) is set in step 903. The timer (T1) is set to elapse for a random amount of time, for example between 5 to 9 seconds, until the timer (T1) reaches zero, in step 905.

Once the timer (T1) has expired, a beep or other notification signal is provided to the player in step 907, and at substantially the same time a shot timer (T2) is started in step 909. The shot timer (T2) counts up the elapsed time. The player then quickly raises the marker into firing position, aims and fires one shot. Once the shot is detected as having been fired in step 911. The process stops the shot timer (T2) in step 913. The elapsed shot time represented by the shot timer (T2) is then displayed on the display screen of the information display and communication device of the present invention. Preferably, the shot time is displayed in seconds and tenths of a second.

Reloading a paintball marker quickly is essential to winning. The process of reloading a paintball marker can be somewhat cumbersome and awkward. Once a player runs out of paintballs, the player must retrieve a new canister of paintballs from a holster or pack; flip the lid up on the hopper of the paintball marker; and position the canister over the opening of the hopper so that the paintballs can flow from the canister into the hopper. Once the canister is empty, the player flips the lid back over the hopper opening, and can once again commence firing. The reload drill 609 provides a way for the player to measure and improve his or her reloading speed.

With the marker unloaded, the player selects the reload drill mode in step 1001. A random timer (T1) is set in step 1003 to count down a random interval between 5 and 9 seconds. Once the random interval set by the timer (T1) has reached zero in step 1005, the mode generates a beep in step 1007. Substantially simultaneous to the beep generation, a reload timer (T3) is started in step 1009. The reload timer (T3) counts up the elapsed time while the player carries out the process of reloading the marker.

Once the player completes the reload process, the player fires a shot in step 1011. With the detection of the shot being fired, the reload timer (T3) is stopped in step 1013. Finally, the elapsed reload time, represented by the reload timer (T3) is displayed in step 1015.

The reload monitor 611 trains a player to be aware of when the paintball marker is empty and to make it a habit to reload immediately. The reload monitor 611 is one of the only drill modes discussed herein that maintains normal operation of the paintball marker, meaning that dwell time is maintained at a normal duration and the marker can be operated with paintballs in the hopper.

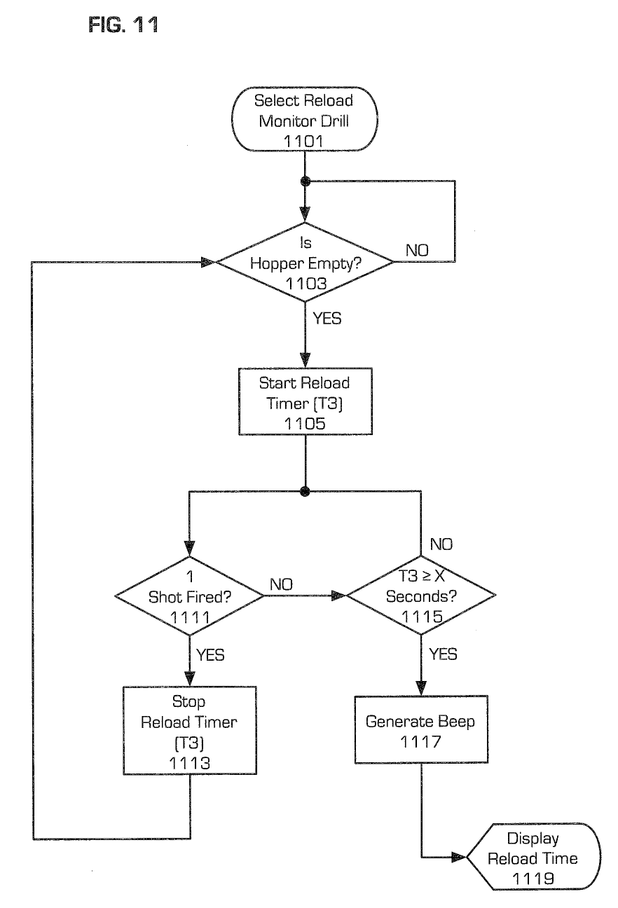

The reload monitor, shown in FIG. 11, operates continuously to monitor the amount of time that a player takes to reload a marker The monitor begins with the selection of the mode in step 1101. The player uses the marker as normal, firing paintballs at a target, practicing or during a game. When the hopper is empty, as detected by the breach sensors in the hopper, a reload timer (T3) is started in step 1105. As the reload timer (T3) counts up, the process waits for a shot to be fired and detected in step 1111.

If while waiting for a shot to be fired, the reload timer (T3) equals or exceeds a predetermined threshold time (X), typically 7 seconds, the process generates a beep in 1117 to notify the player that he or she is too slow reloading the marker. The elapsed reload time (T3) is also displayed to the player in step 1119. On the other hand, if a shot is detected in step 1111 before T3≧X seconds the drill stops the reload timer (T3) in step 1113. The process then returns to step 1103.

The front players on a team play the role of advancing and establishing forward positions. Front players generally need to be proficient at racing to forward bunker positions quickly and diving or sliding in order to present as small a target to the opponent side as possible. The front player drill 613 provides training for a player to practice and improve these skills.

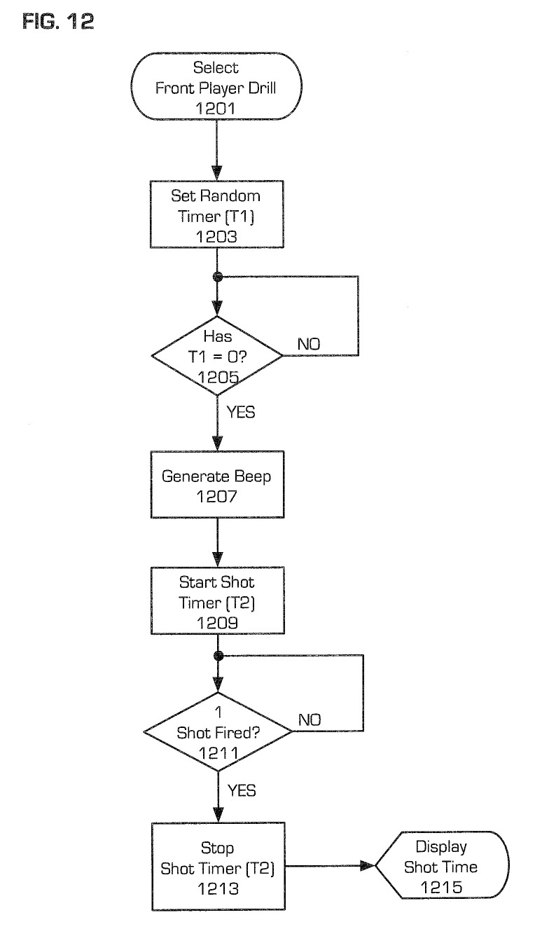

Referring to FIG. 12, the front player drill of the present invention is initiated in step 1201. A random timer (T1) is set in step 1203 to count down a random number of seconds, preferably between 5 and 9 seconds. Once the random timer (T1) has counted down to zero, in step 1205, a beep or other notification is generated in step 1207. The player will, upon hearing the beep, run to a bunker, diver or slide, and fire a shot.

Substantially simultaneous with the beep generation, a shot timer (T2) is started in step 1209. The shot timer (T2) tracks the elapsed time until a shot is fired in step 1211. In step 1213, the shot timer (T2) is stopped once a shot has been fired. The front player drill terminates with the elapsed time of the shot timer (T2) being displayed to the player in step 1215. The displayed time corresponds with the time required by the player to get into position and begin firing at an opponent.

The “Ollie Lang” drill 615, also known as a 3-shot snap-shot drill, provides a player an opportunity to practice snap-shooting. Snap-shooting is a firing technique where a player uses a bunker or other feature to shield themselves from the opposing team, generally the player crouches or kneels to present as small a target as possible to the opposing team as well. The player then “snaps” out from behind and fires one to three shots at an opposing player. The player then completes the technique by “snapping” back behind the bunker. Ideally, the process of snapping out, aiming, firing and snapping back is executed as quickly as possible to avoid allowing the opposing team to fire back.

The “Ollie Lang” drill is initiated in step 1301 with selection of the mode in the provided interface of the present invention. The mode initializes a shot counter (N) to a value of 1 in step 1303. In step 1305 a random timer (T1) is set to count down a random number of seconds until the timer (T1) reaches zero at step 1307. Once the timer (T1) reaches zero, a beep or other notification is generated in step 1309 and a shot timer (T2N) is started for the shot value of the shot counter N.

Upon hearing the beep, the player snaps out from behind the bunker or other feature and fires one shot. Once the shot is fired in step 1313, the process continues to step 1315. At step 1315, the shot timer (T2N) is stopped and the elapsed time is stored. If the shot counter (N) is equal to 3 in step 1317 the cumulative shot times are displayed in step 1321. Otherwise, if the shot counter (N) is less than 3 the process continues to step 1319 where the shot counter (N) is incremented by 1 (i.e., N=N+1). Once incremented, the process returns to step 1305 where a new random timer (T1) is started with a newly selected random countdown time. The remaining steps (steps 1311-1321) are performed as discussed above for the new value of N until a new shot time (T2N) is stored for N=2 and again for N=3. Once all three shots have been fired, the drill ends and the cumulative shot times are displayed in step 1321.

The 50-shot endurance drill 617, as the name implies, provides endurance training for a player, combining shooting and running simultaneously towards a target. Shooting while running is one of the most import skills of a paintball player. This drill helps improve accurate shooting while running, speed and endurance.

The 50-shot endurance drill commences in step 1401 once the player has selected the drill mode in the interface of the information display and communication device of the present invention. A shot counter (N) is initialized at N=0 in step 1403 and a random timer (T1) is set to count down a random number of seconds in step 1405. Once the timer (T1) reaches zero in step 1407, the process continues to step 1409 where a beep is generated. A shot timer (T2) is started in step 1411 which tracks the elapsed time until completion of the 50-shot endurance drill

Once the player hears the beep, the player runs and continuously fires the marker until 50 shots are registered as having been fired in step 1417. As each new shot is fired, the shot counter (N) is incremented by 1 (i.e., N=N+1) in step 1415. When in step 1417 the shot counter (N) is equal to 50 the shot timer (T2) is stopped in step 1419 and the total elapsed shot time (T2) is displayed, thus ending the drill. A second beep may also be generated to signal completion of the drill.

While the drill modes have been described as operating, for the most part, with a marker that is unloaded and with a reduced dwell time, the present invention is not limited to this embodiment, rather, the present invention can be equipped with a user selectable option to allow the drill modes to operate with a loaded and fully functioning marker. With this option, the player can visually verify accuracy of shots taken rather than simply assuming that a shot fired has hit the intended target.

The described embodiments of the present invention are intended to be illustrative rather than restrictive, and are not intended to represent every embodiment of the present invention. Various modifications and variations can be made without departing from the spirit or scope of the invention as set forth in the following claims both literally and in equivalents recognized in law.

What is claimed is:

1. An information unit for use with a paintball marker system, said information unit comprising:
a portable housing;
a display unit disposed on said housing;
a first wireless communication unit provided in said housing for receiving information from said paintball marker system; and
a controller provided in said housing for displaying said received information on said display unit.

2. The information unit as in claim 1, wherein said first wireless communication unit utilizes a short range communication protocol.

3. The information unit as in claim 1, wherein said first wireless communication unit includes a command transmitting unit for transmitting operation commands to said paintball marker system.

4. The information unit as in claim 3, wherein said operating commands include commands for setting rate of fire.

5. The information unit as in claim 1, further comprising a position determining unit for determining current position of said information unit with respect to at least a play area.

6. The information unit as in claim 5, wherein said position determining unit is one of a Global Positioning Satellite (GPS) receiver, one or more accelerometers, or a combination of said GPS receiver and said one or more accelerometers.

7. The information unit as in claim 1, further comprising a touch screen input unit overlaid on said display unit for providing user interaction with said information unit.

8. The information unit as in claim 1, further comprising a second wireless communication unit for receiving external information.

9. The information unit as in claim 8, wherein said external information is a status of teammates and said teammates' paintball markers.

10. The information unit as in claim 8, wherein said external information includes maps of a current play area.

11. The information unit as in claim 8, wherein said second wireless communication unit utilizes a communication protocol having a range longer than said first wireless communication unit.

12. The information unit as in claim 8, wherein said information unit is uniquely addressable over said second wireless communication unit.

13. The information unit as in claim 8, wherein said second wireless communication unit transmits and receives dialogue communication between two or more teammates.

14. The information unit as in claim 1, wherein said information unit is mountable to an area of said paintball marker system.

15. The information unit as in claim 1, wherein said information unit is wearable by a player.

16. The information unit as in claim 15, wherein at least a portion of said information unit is disposed on a paintball mask.

17. The information unit as in claim 1, further comprising a plurality of training modes accessible through a user interface.

18. The information unit as in claim 17, wherein said information unit reduces dwell time when operating in at least one of said training modes.

19. The information unit as in claim 17, wherein said information unit provides access to said training modes when said marker is unloaded.

20. The information unit as in claim 17, wherein said training modes comprise:
notifying means for notifying a user of a start of said training mode;
one or more timers for tracking elapsed time until completion of a selected training mode of said training modes; and
a display for providing results of said selected training mode once completed.

21. A paintball marker system comprising:
a paintball marker;
a display unit disposed on an area of said paintball marker viewable by a user;
a first wireless communication unit provided in said paintball marker for receiving information from said paintball marker and a paintball hopper; and
a controller provided in said paintball marker for displaying said received information on said display unit.

22. The paintball marker system as in claim 21, wherein said first wireless communication unit includes a command transmitting unit for transmitting operation commands to said paintball marker and said paintball hopper.

23. The paintball marker system as in claim 22, wherein said operating commands include commands for setting rate of fire.

24. The paintball marker system as in claim 21, further comprising a position determining unit for determining current position of said paintball marker system with respect to at least a play area, said position determining unit being one of a Global Positioning Satellite (GPS) receiver, one or more accelerometers, or a combination of said OPS receiver and said one or more accelerometers.

25. The paintball marker system as in claim 21, further comprising a touch screen input unit overlaid on said display unit for providing user interaction with said information unit.

26. The paintball marker system as in claim 21, farther comprising a second wireless communication unit for receiving external information.

27. The paintball marker system as in claim 26, wherein said external information is status of teammates and said teammates' paintball markers.

28. The paintball marker system as in claim 26, wherein said external information includes maps of a current play area.

29. The paintball marker system as in claim 26, wherein said second wireless communication unit utilizes a communication protocol having a range longer than said first wireless communication unit.

30. The paintball marker system as in claim 26, wherein said paintball marker system is uniquely addressable over said second wireless communication unit.

31. The paintball marker system as in claim 26, wherein said second wireless communication unit transmits and receives dialogue communication between two or more teammates.

32. A paintball hopper comprising:
A hopper body having a central chamber for holding a volume of paintballs;
a display unit disposed on an area of said hopper body and positioned to be viewable by a user;
a first wireless communication unit provided on said hopper body for receiving information from a paintball marker and said paintball hopper; and
a controller provided on said hopper body for displaying said received information on said display unit.

33. The paintball hopper as in claim 32, wherein said first wireless communication unit includes a command transmitting unit for transmitting operation commands to said paintball marker and said paintball hopper.

34. The paintball hopper as in claim 33, wherein said operating commands include commands for setting rate of fire.

35. The paintball hopper as in claim 32, further comprising a position determining unit for determining current position of information unit with respect to at least a play area, said position determining unit being one of a Global Positioning Satellite (GPS) receiver, one or more accelerometers, or a combination of said OPS receiver and said one or more accelerometers.

36. The paintball hopper as in claim 32, further comprising a touch screen input unit overlaid on said display unit for providing user interaction with said information unit.

37. The paintball hopper as in claim 32, further comprising a second wireless communication unit for receiving external information.

38. The paintball hopper as in claim 37, wherein said external information is status of teammates and said teammates' paintball markers.

39. The paintball hopper as in claim 37, wherein said external information includes maps of a current play area.

40. The paintball hopper as in claim 37, wherein said second wireless communication unit utilizes a communication protocol having a range longer than said first wireless communication unit.

41. The paintball hopper as in claim 37, wherein said paintball hopper is uniquely addressable over said second wireless communication unit.

42. The paintball hopper as in claim 37, wherein said second wireless communication unit transmits and receives dialogue communication between two or more teammates.

43. A method for improving paintball skills using an information unit in communication with a paintball marker system, said method comprising:
providing a plurality of training modes selectable by a user through an interface of said information unit;
signaling a start of a selected training mode of said plurality of training modes at a random interval after selection of said selected training mode;
tracking at least one elapsed time from said signaled start of said selected training mode until completion of said selected training mode;
displaying said at least one elapsed time upon completion of said selected training mode.

44. The method as in claim 43, wherein a dwell time of said marker system is reduced during at least one of said plurality of training modes.

45. The method as in claim 43, wherein completion of said selected training mode occurs once a predetermined number of shots are registered as having been fired in said selected training mode.
